(19) United States
(12) Patent Application Publication
(10) Pub. No.: US 2014/0279533 A1
(43) Pub. Date: Sep. 18, 2014

(54) REAL-TIME APPLICATION PROGRAMMING INTERFACE FOR MERCHANT ENROLLMENT AND UNDERWRITING

(71) Applicants: Brian HAMILTON, San Francisco, CA (US); Mark Blythe, Edmonds, WA (US)

(72) Inventors: Brian HAMILTON, San Francisco, CA (US); Mark Blythe, Edmonds, WA (US)

(73) Assignee: Capital One Financial Corporation, McLean, VA (US)

(21) Appl. No.: 14/202,444

(22) Filed: Mar. 10, 2014

Related U.S. Application Data
(60) Provisional application No. 61/789,813, filed on Mar. 15, 2013.

(51) Int. Cl. G06Q 40/00; G06Q 20/40

(52) U.S. Cl. CPC G06Q 40/00; G06Q 20/4016
USPC 705/44; 705/35

(57) ABSTRACT

The disclosed embodiments include methods and systems for providing a real-time application programming interface for merchant enrollment and underwriting. In one embodiment, a process is disclosed that may include receiving, from a first computing device, a request for applying for the merchant financial account for a merchant applicant. The request may also include verifying the information associated with the merchant applicant and providing, via the first computing device, at least one question with a plurality of answer choices to the merchant applicant if the merchant applicant information associated with the applicant is verified. In one aspect, the method may include receiving an answer choice to the at least one question from the merchant applicant via the first computing device and validating the received answer choice. If the answer choice is validated, the method may include activating the first computing device and authenticating the merchant applicant for the merchant financial account.

### PRIORITY CLAIM

This disclosure claims priority under 35 U.S.C. §119 to U.S. provisional patent application No. 61/789,813, filed on Mar. 15, 2013, and entitled “Real-time Application Programming Interface for Merchant Enrollment and Underwriting.” The aforementioned application is incorporated herein by reference in its entirety.

### BACKGROUND

Merchants have increasingly accepted financial card payments for goods and/or services they provide, because financial cards are more convenient and cost effective for collecting payments from customers. Merchants who want the capability to process financial card payments, either through payment machines (e.g., Point of Sale (POS) systems) at their store locations, or through online payment mechanisms, typically have a merchant account with at least one merchant service provider, such as, for example, payment Processors (also known as Acquirers) and resellers (e.g., Independent Sales Organizations and/or Merchant Service Providers). The process of merchant enrollment and underwriting primarily involves setting up a merchant account.

Merchant enrollment and underwriting, however, may be a complicated process. Typically, an agent of a merchant may either fill out paperwork and deliver it to a merchant service provider, or log onto the website of a merchant service provider, manually enter information into input fields presented in interfaces, and complete the enrolling process on that website. Conventional processes for configuring merchant accounts, however, lack of system-to-system exchange of information. For example, enrollment processes may be restricted to website processes provided by the merchant service provider. Thus, a merchant service provider, reseller, or other processor may not have the flexibility to develop an application that may be installed on a customer's computing device (e.g., smartphone, laptop, etc.) for applying for a merchant account. Also, current approaches do not support server-to-server communication from related systems, which limits the access to information. In addition, the lack of server-to-server communications results in delays in processing merchant accounts for customers. In some cases, a merchant may have to wait days to complete enrollment in a payment processing system provided by a merchant service provider.

### SUMMARY

The disclosed embodiments include, for example, systems and methods for providing a real-time application programming interface (“the API”) that may be used for enrolling and underwriting a merchant in a merchant service system that enables the merchant to process financial card payments.

In one embodiment, a system is disclosed that may include, for example, one or more memory devices storing software instructions. The system may also include one or more processors configured to execute the software instructions to receive, from a first computing device and through a real-time API configured to provide real-time merchant financial account configuration processes with a financial service provider, a request for applying for the merchant financial account for a merchant applicant, the request including merchant applicant information. The one or more processors may also be configured to verify the information associated with the merchant applicant, and provide, via the first computing device, at least one question with a plurality of answer choices to the merchant applicant if the merchant applicant information associated with the applicant is verified. The one or more processors may also be configured to receive an answer choice to the at least one question from the merchant applicant via the first computing device, and validate the received answer choice. Further, the one or more processors may also be configured to activate the first computing device if the answer choice is validated, and authenticate the merchant applicant for the merchant financial account.

The disclosed embodiments may also include a system for providing merchant accounts for transacting financial card transactions with customers. The system may include a memory device storing a real-time API that is configured according to parameters to enable communications to a financial service provider for configuring a merchant account for a merchant and one or more processors configured to execute software instructions to use the real-time API to perform one or more operations. In one aspect, the operations may include collecting individual information including name of an individual representing a merchant, and merchant information associated with the merchant. The operations may also include automatically providing the individual information and merchant information to a verification service provider for verifying the identity of the individual to act on behalf of the merchant, and for analyzing risk mitigating factors associated with the individual and merchant information. The operations may further include automatically presenting information relating to a gateway account in response to a verification result received from the verification service provider, the gateway account being associated with a processing gateway. In another aspect, the operations may include receiving notification of a pre-built customer account record on an acquiring system that is associated with the gateway account, and of functioning credentials for transacting financial card payments from customers of the merchant using the merchant account.

The disclosed embodiments may also include a method for providing the real-time API for enrolling and underwriting a merchant in a merchant service system that enables the merchant to process financial card payments. The method may include, for example, receiving, from a first computing device and through a real-time API configured to provide real-time merchant financial account configuration processes with a financial service provider, a request for applying for the merchant financial account for a merchant applicant, the request including merchant applicant information. The request may also include verifying the information associated with the merchant applicant and providing, via the first computing device, at least one question with a plurality of answer choices to the merchant applicant if the merchant applicant information associated with the applicant is verified. In one aspect, the method may include receiving an answer choice to the at least one question from the merchant applicant via the first computing device and validating the received answer choice. If the answer choice is validated, the method may include activating the first computing device and authenticating the merchant applicant for the merchant financial account.

Although disclosed embodiments are discussed primarily in the context of enrolling and underwriting merchant in a merchant service system, other applications are contemplated. For example, the disclosed embodiments may also be used for processing payment transactions once the merchant has been enrolled in the merchant service system.

It is to be understood that both the foregoing general description and the following detailed description are exemplary and explanatory only and are not restrictive of the disclosed embodiments, as claimed.

### BRIEF DESCRIPTION THE DRAWINGS

The accompanying drawings, which are incorporated in and constitute a part of this specification, illustrate various embodiments and aspects of the disclosed embodiments, and together with the description, serve to explain the principles of the disclosed embodiments.

FIG. 1 illustrates an exemplary system consistent with disclosed embodiments.

FIG. 2 is a block diagram of one or more process flows associated with an exemplary arrangement consistent with disclosed embodiments.

FIG. 3 is another block diagram of one or more process flows associated with an exemplary arrangement consistent with disclosed embodiments.

FIG. 4 is a flowchart of an exemplary merchant enrollment and underwriting process, consistent with disclosed embodiments.

FIGS. 5A-C each is a table containing exemplary input parameters associated with information collecting process, consistent with disclosed embodiments.

FIG. 6 is a table containing exemplary input parameters associated with question retrieving process, consistent with disclosed embodiments.

FIG. 7 is a table containing exemplary input parameters associated with answer validating process, consistent with disclosed embodiments.

FIG. 8 is a table containing exemplary input parameters associated with device activating process, consistent with disclosed embodiments.

FIG. 9 is a table containing exemplary input parameters associated with merchant user authenticating process, consistent with disclosed embodiments.

FIG. 10 is a table containing exemplary input parameters associated with client authenticating process, consistent with disclosed embodiments.

FIG. 11 is a table containing exemplary input parameters associated with ZIP code checking process, consistent with disclosed embodiments.

FIG. 12 is a table containing exemplary input parameters associated with plan listing process, consistent with disclosed embodiments.

FIG. 13 is a table of exemplary input parameters associated with industry type listing process, consistent with disclosed embodiments.

FIG. 14 is a table containing exemplary input parameters associated with Ping process, consistent with disclosed embodiments.

FIG. 15 is a table containing exemplary warning code, consistent with disclosed embodiments.

FIG. 16 is a table containing exemplary error codes, consistent with disclosed embodiments.

### DETAILED DESCRIPTION

Disclosed embodiments include, for example, systems and processes for providing a real-tune application programming interface (“the API”), which may be developed as a web service for enrolling and underwriting merchants in merchant service systems provided by one or more financial service providers (such as, for example, merchant service providers). In certain embodiments, a real-time API consistent with certain disclosed embodiments may use Representational State Transfer (REST) style architecture, and in this scenario, the real-time API may be called a RESTful API.

In certain embodiments, the real-time API may include a set of Hypertext Transfer Protocol (HTTP) request messages and a definition of the structure of response messages. In certain aspects, the API may allow a software application, which is written against the API and installed on a client (such as, for example, a computing device associated with a merchant) to exchange data with a server (such as, for example, a computing system associated with a financial service provider) that implements the API, in a request-response pattern. In certain embodiments, the request-response pattern defined by the API may be configured in a synchronous fashion, and require that the response be provided in real-time. In some embodiments, a response message from the server to the client through the API consistent with the disclosed embodiments may be in the format including, for example, Extensible Markup Language (XML), JavaScript Object Notation (JSON), and/or the like.

In some embodiments, the design of the API may require that the request-response calls include a valid application ID. The application ID may be used to identify a merchant account application, and may be a number pre-built by a merchant service provider and stored in a database, or a random ID assigned to an applicant for the merchant account. For example, the application ID may be assigned by a server associated with the merchant service provider when a user initiates the merchant enrollment via a client, and it may be used to identify a merchant account application. In one aspect, the design of the API may also designate specific request methods for a client to access to the server. For example, the client may send GET and POST requests with parameters url-encoded (GET) in the query string or form-encoded (POST) in the body (e.g., a form submission). Additionally or alternatively, the client may send GET and POST requests with JSON serialized parameters in the body. Preferably, the requests with JSON serialized parameters use “application/son” content-type. In another aspect, the design of the API may also require the server implementing the API return messages in JSON format in response to the request calls from the client.

Reference will now be made in detail to the disclosed embodiments, examples of which are illustrated in the accompanying drawings. Wherever convenient, the same reference numbers will be used throughout the drawings to refer to the same or like parts.

FIG. 1 is a diagram illustrating an exemplary system 100 for performing one or more operations consistent with the disclosed embodiments. In one embodiment, system 100 may include a financial service provider 110, a merchant 120, a financial institution 150, a verification service provider 160, and network 140. The components and arrangement of the components included in system 100 may vary. Thus, system 100 may further include other components that perform or assist in the performance of one or more processes consistent with the disclosed embodiments.

Financial service provider 110 may be an entity that provides merchant services and processes applications for merchant accounts. For example, financial service provider 110 may be a bank, credit card issuer, or other type of financial service entity that generates, provides, manages, and/or maintains merchant accounts. In one embodiment, financial service provider 110 may generate, provide, manage, and/or maintain merchant accounts for one or more merchants. In one embodiment, a merchant account may be a financial account associated with a merchant, such as merchant 120. Financial service provider 110 may be a payment Processor (also known in the industry as an Acquirer), or may be a reseller, such as, for example, Independent Sales Organizations (ISO's) and/or Merchant Service Providers (MSP's).

In one embodiment, financial service provider 110 may include one or more computing systems that are configured to execute software instructions stored on one or more memory devices to perform one or more operations consistent with the disclosed embodiments. In one embodiment, financial service provider 110 may include server 111. Server 111 may be one or more computing devices configured to execute software instructions stored in memory to perform one or more processes consistent with the disclosed embodiments. For example, server 111 may include one or more memory device(s) storing data and software instructions and one or more processor(s) configured to use the data and execute the software instructions to perform server-based functions and operations known to those skilled in the art. Server 111 may also be configured to execute stored software instructions to implement the API for providing merchant services and processing applications for merchant accounts in a manner consistent with the disclosed embodiments.

Server 111 may be a general-purpose computer, a mainframe computer, or any combination of these components. When executing software instructions consistent with the disclosed embodiments, server 111 may be configured as a particular computing system for performing one or more operations consistent with the disclosed embodiments. Server 111 may be standalone, or it may be part of a subsystem, which may be part of a larger system. For example, server 111 may represent distributed servers that are remotely located and communicate over a network (e.g., network 140) or a dedicated network, such as a LAN, for financial service provider 110.

Server 111 may include or may connect to one or more storage devices configured to store data and/or software instructions used by one or more processors of server 111 to perform operations consistent with disclosed embodiments. For example, server 111 may include memory configured to store one or more software programs that performs several functions when executed by a processor. The disclosed embodiments are not limited to separate programs or computers configured to perform dedicated tasks. For example, server 111 may include memory that stores a single program or multiple programs. Additionally, server 111 may execute one or more programs located remotely from server 111. For example, server 111 may access one or more remote programs stored in memory included with a remote component that, when executed, perform operations consistent with the disclosed embodiments. In certain aspects, server 111 may include web server software that generates, maintains, and provides web site(s) that are accessible over network 140. In other aspects, financial service provider 110 may connect separate web server(s) or similar computing devices that generate, maintain, and provide web site(s) for financial service provider 110.

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s) such as the exemplary links between financial service provider 110 and financial institution 150, and the exemplary links between financial service provider 110 and verification service provider 160.

Merchant 120 may be an entity that provides goods and/or services, Merchant 120 may be brick and mortar location(s) that a consumer (not shown) may physically visit and purchase goods and/or services. Such physical locations may include computing devices that perform financial service transactions with consumers (e.g., POS terminal(s), kiosks, etc.). Merchant 120 may also include back and/or front-end computing components that store data and execute software instructions to perform operations consistent with disclosed embodiments, such as computers that are operated by employees of merchant 120 to process payment transactions. In certain embodiments, merchant 120 may also provide electronic shopping mechanisms, such as a website or similar online location that consumers may access using a computer (not shown) through browser software or similar software.

In one embodiment, merchant 120 may include one or more computing systems that are configured to execute software instructions stored on one or more memory devices to perform one or more operations consistent with the disclosed embodiments. In one embodiment, merchant 120 may include client 121. Client 121 may be one or more computing devices that are configured to execute software instructions for performing one or ore operations consistent with the disclosed embodiments. Client 121 may be a desktop computer, a laptop, a server, a mobile device (e.g., tablet, smartphone, etc.), and any other type of computing device. Client 121 may include one or more processors configured to execute software instructions stored in memory, such as memory included in client 121. Client 121 may include software that when executed by a processor performs known Internet-related communication and content display processes. For instance, client 121 may execute browser software that generates and displays content on a display device included in, or connected to, client 121. The disclosed embodiments are not limited to any particular configuration of client 121. For instance client 121 may be a mobile device that stores and executes mobile applications that provide financial service related functions offered by financial service provider 110, such as an enrollment application for setting up a merchant account. In some embodiments, client 121 may include mobile applications that are written against the API to retrieve information from a server that implements the API (e.g., server 111).

In some embodiments, merchant 120 may also include one or more servers (“the merchant server”) (not shown), which may be one or more computing devices configured to execute software instructions stored in memory to perform one or more processes consistent with the disclosed embodiments. In some embodiments, one computing device may serve as both the merchant server and client 121, and the computing device may be configured to execute software instructions for performing more than one operation consistent with the disclosed embodiments. In certain aspects, the merchant server may include web server software that generates, maintains, and provides web site(s) for consumers (not shown) that is accessible over network 140. In other aspects, the merchant server may connect to separate web server(s) or similar computing devices that generate, maintain, and provide web site(s) for consumers. For example, the merchant server may use web server(s) that provide a web site specific to a consumer, and allows the consumer to access, view, and purchase goods and/or services from merchant 120.

In some embodiments, merchant 120 may process financial card payments made by a consumer for purchasing its goods and/or services. In one aspect, the financial card may be a physical plastic credit or check card that the consumer may carry on his/her person. In another aspect, the financial card may be an electronic card, such as a digital wallet or similar E-card that the consumer may have stored in an electronic wallet, mobile device, etc. The consumer may use the financial card to purchase goods and/or services at a point of sale (POS) terminal or similar system associated with merchant 120. The financial card may be associated with a financial service accounts provided by a financial institution (e.g., financial institution 150), and the financial service accounts may include, for example, credit card accounts, checking accounts, savings accounts, reward accounts, and any other types of financial service account known to those skilled in the art.

In one embodiment, merchant users associated with merchant 120 may use client 121 to perform one or more operations consistent with the disclosed embodiments. For example, merchant user 101 may use client 121 for initiating an application for merchant account, submitting the application to financial service provider 110, and completing the enrollment and underwriting process.

Financial institution 150 may be an entity that provides financial services. For example, financial institution 150 may be a bank, credit card issuer, or other type of financial service entity that generates, provides, manages, and/or maintains financial service accounts for one or more consumers. In some embodiments, financial institution 150 may serve as financial service provider 110. In this scenario, financial service provider 110 may additionally provide services that provided by financial institution 150. Financial institution 150 may include infrastructure and components that are configured to generate and provide financial service accounts and financial service account cards (similar to those discussed above) that consumers may use to purchase goods and/or services provided by merchant 120.

In one embodiment, financial institution 150 may include one or more computing systems that are configured to execute software instructions stored on one or more memory devices to perform one or more operations consistent with the disclosed embodiments. In one embodiment, financial institution 150 may include server 151. Server 151 may be one or more computing devices configured to execute software instructions stored in memory to perform one or more processes consistent with the disclosed embodiments. For example, server 151 may include one or more memory device(s) storing data and software instructions and one or more processor(s) configured to use the data and execute the software instructions to perform server-based functions and operations known to those skilled in the art. Server 151 may also be configured to execute stored software instructions to perform operations for communicating with server 111 to approve or decline a financial service transaction between a consumer and merchant 120 that involves a financial card issued by financial institution 150. Server 151 may be a distributed computing system that includes computing systems distributed in different locations and connected via a network, such as a local area network, network 140, etc.

Verification service provider 160 may be an entity that provides identity verification services. For example, verification service provider 160 may be an entity that provides identity verification services to financial service provider 110 in merchant enrollment and underwriting process. Verification service provider 160 may include server 161. Server 161 may be one or more computing systems that are configured to execute software instructions stored on one or more memory devices to perform one or more operations consistent with the disclosed embodiments. For example, server 161 may include one or more memory device(s) storing data and software instructions and one or more processor(s) configured to use the data and execute the software instructions to perform server-based functions and operations known to those skilled in the art. Server 161 may also be configured to execute stored software instructions to perform operations for communicating with server 111 to verify the information provided by merchant user 101 (or additionally or alternatively, its representative). Server 161 may be a distributed computing system that includes computing systems distributed in different locations and connected via a network, such as a local area network, network 140, etc.

In one embodiment, the one or more memory devices of server 161 may include database for storing data associated with, for example, merchant 120 and/or merchant user 101. As an example, server 161 may include a memory, which includes any combination of one or more databases controlled by memory controller devices or software, such as document management systems, Microsoft SQL databases, SharePoint databases, Oracle™ databases, Sybase™ databases, or other relational databases. In some embodiments, one or more databases may be used to store information associated with merchant 120 and/or merchant user 101 for verifying the information provided by merchant user 101 in the merchant enrollment and underwriting process. One or more databases may also be used to store at least one question along with a plurality of answer choices (“the question/answer set(s)”). In one embodiment, the question/answer set(s) may be used in the merchant enrollment and underwriting process for verifying the information provided by merchant user 101 in the merchant enrollment and underwriting process. The disclosed embodiments are not limited to any particular configuration of the computing components used by verification service provider 160.

As explained, the disclosed embodiments include methods and systems for providing a real-t time API for enrolling and underwriting merchants in merchant service systems that enable the merchants to process financial card payments. FIG. 2 shows a block diagram of process flows associated with the use of a real-time API configured in accordance with disclosed embodiments for configuring merchant accounts. The exemplary process flows may involve operations performed by one or more components of a system consistent with disclosed embodiments. In one aspect, financial service provider 210 may provide merchant services that enable merchants to process financial card payments. Financial service provider 210 may be similar to, and include one or more computing systems that are configured to perform the same operations as, financial service provider 110. Accordingly, the descriptions of financial service provider 110 may equally apply to financial service provider 210. In one embodiment, financial service provider 210 may provide a merchant account to a merchant, and underwrite the merchant in connection with financial transactions (e.g., financial card payments). In one aspect, financial service provider 210 may include one or more computing systems, such as server 211. Server 211 may be configured to perform the same or similar functions as server 111. Accordingly, the descriptions of server 111 may equally apply to server 211. Financial service provider 210 may also include one or more memories (e.g., database(s)) for storing information including, for example, merchant account IDs that may be used to qualify selected merchants. In one embodiment, financial service provider 210 may generate and store pre-built merchant account IDs in a backend database (S201). Additionally or alternatively, the merchant account IDs may be generated and stored by financial institution 250, a third party that may be authorized by financial service provider 210 and/or financial institution 250 to generate and store the merchant account IDs, any institution that may participate in the financial card payment transaction, or the like. In some embodiments, the merchant account IDs may be built with default information such as, for example, information relating to merchants (e.g., merchant 120). In one aspect, upon receiving the data entered by merchant user 201, the default information may be overwritten and replaced by the inputs from merchant user 201.

In one aspect of the disclosed embodiments, a merchant user (e.g., merchant user 201) associated with a merchant (e.g., merchant 120) may initiate an application for enrolling the merchant in the merchant service systems provided by financial service provider 210 (S203). In some embodiments, merchant user 201 may use client 221 for performing the merchant enrollment and underwriting process. In one embodiment, client 221 may be a desktop computer, a laptop, a server, a mobile device (e.g., tablet, smart phone, etc.), and any other type of computer device. Client 221 may include software that when executed by a processor performs known Internet-related communication and content display processes. For instance, client 221 may execute browser software that generates and displays interfaces including content on a display device included in, or connected to, client 221. In one embodiment, merchant user 201 may use the browse software on client 221, and access to the website page provided by server 211 for performing the merchant enrollment and underwriting process. In another embodiment, client 221 may be a mobile device that stores and executes mobile applications that provide financial service related functions offered by financial service provider 210, such as processing merchant enrollment and underwriting. Merchant user 201 may use the mobile applications on 221 to perform the enrollment and underwriting process.

In some disclosed embodiments, to enroll in the merchant service system provided by financial service provider 210, merchant user 201 may need to provide personal information and/or information associated with the merchant. The information may include, for example, the name of merchant user 201, business name of the merchant, business address, tax ID number(s) for merchant user 201 and/or the merchant, business phone number, business website, etc.

In some embodiments, verification service provider(s) 260 may provide verification services associated with merchant enrollment and underwriting (S205). In some embodiments, verification service provider 260 may include server 261. The configuration and operation of server 261 may be similar or the same as sever 161 as disclosed herein. In one embodiment, server 211 may provide the information provided by merchant user 201 to server 261 for verification. In one aspect, verification service provider 260 may include one or more database(s) that store information relating to merchant user 201 and/or the merchant. In some embodiments, server 261 may use database(s) to verify the information provided by merchant user 201 and report the verification results to server 211 in real-time.

In some embodiments, if verification service provider 260 verifies the information provided by merchant user 201 (e.g., passes an identification check), server 211 may create an account for the merchant and assign the account with a merchant account number (S207) (e.g. client ID number). In one aspect, server 211 may store the merchant account information in the database(s) of financial service provider 210. The merchant account may include the information provided by merchant user 201, merchant account number, and/or other information relating to the merchant.

In some embodiments, server 211 may also create a gateway account for the merchant (S209). In one aspect, the gateway account may be provided by a third party, such as, for example, gateway service provider 215. Gateway service provider 215 may include a gateway database that stores the gateway account for merchants. Gateway service provider 215 may include a computing system (e.g., one or more servers) that executes software to perform operations, including operations consistent with the disclosed embodiments. Gateway service provider 215 may communicate with one or more components of the disclosed embodiments (e.g., financial service provider 210, merchant user 201, verification service provider 260, etc. over a network, such as, for example, network 140). In some embodiments, server 211 may correlate the merchant account stored in the database(s) of financial service provider 210 with the merchant's gateway account stored in the gateway account database.

In some embodiments, the application software stored on client 221 may be activated once the merchant has received the merchant account and the disclosed embodiments have configured the account and the gateway account. In one aspect, the merchant may process financial card payments associated with purchase transactions with customers once the application software is activated (S211).

In certain embodiments, financial service provider 210 (via server 211) may also evaluate one or more risk factors associated with a merchant when considering and configuring a merchant account for the merchant. For example, financial service provider 210 (via server 211) may analyze the risk factors to determine whether or what type of merchant services to provide to the merchant (S213). In one aspect, server 261 may gather information associated with the financial risk factors of merchant user 201 and/or the merchant, check the credit record of merchant user 201 and/or the merchant, review and evaluate the risk factors, and report the risk evaluation results to server 211. In some embodiments, server 211 may determine the financial restrictions of the merchant services it may provide to the merchant based on the risk evaluation results provided by server 261. For instance, server 211 may execute software that performs one or more algorithms and analyzes and/or generates one or more matrixes to apply initial transaction limits to a particular merchant, and set credit volumes according to the risk factors associated with this particular merchant. In some embodiments, server 211 may also store the risk information in one or more database(s).

In some embodiments, server 211 may update the merchant account when new information is added (S215). For example, server 211 may update the merchant account to include results from the risk factor analysis.

A merchant that receives a merchant account from financial service provider 210 may process financial card payments. For example, a customer may place an order with the merchant who has enrolled in the merchant service systems provided by financial service provider 210, and the merchant may process financial card payments consistent with the disclosed embodiments. In one aspect, the customer may place the order in a number of ways including, for example, pressing “submit order” or equivalent button on a website provided by client 221, entering customer's financial card information through an automatic phone answering service, and/or presenting and swiping the financial card at the merchant's store (S221). The disclosed embodiments are not limited to particular manners and configurations of how customers initiate purchase orders with a merchant. In some embodiments, the merchant may forward the transaction details to payment gateway 217, which may be a financial payment service provided by gateway service provider 215 (S223). In one aspect, payment gateway 217 may forward the transaction information to the payment processor that underwrites the merchant (e.g., financial service provider 210) (S225). Server 211 of financial service provider 210 may forward the transaction information to a financial institution that issues the financial card to the customer (e.g., financial institution 250) (S227). Financial institution 250 may be a financial service provider that provides financial services to users (e.g., customers, etc.). In some embodiments, financial institution 250 (via one or more processors) may conduct fraud and credit or debit checks and may send a response back to financial service provider 210. In one aspect, financial service provider 210 (via server 211) may forward the authorization (if financial institution 250 authorizes the transaction) response to payment gateway 217 (S229). In one aspect, payment gateway 217 may forward the response to the merchant (S231). The merchant may fulfill the order placed by the customer if the payment transaction is authorized.

FIG. 3 shows another block diagram of one or more process flow associated with an exemplary arrangement consistent with the disclosed embodiments. The exemplary process flow may be provided through the real-time API configured in accordance with the disclosed embodiments. In one aspect, merchant user 101 (e.g., an employee or any person that represents merchant 120) may initiate an enrollment process on behalf of merchant 120. In one aspect, merchant user 101 may provide his/her personal information including, for example, name, address, SSN, telephone number, and the like (S301). Merchant user 101 may also provide information associated with merchant 120 (S303). The information may include, for example, business type, address, website, and the like.

In one aspect, server 111 may verify the information received from merchant user 101. In one embodiment, server 111 may communicate with a server (e.g., server 161) at one or more verification institutions (e.g., verification service provider 160), and verify the information received from merchant user 101 (S305). For instance, server 111 may request server 161 to query an ID verification database provided by verification service provider 160 to perform verification. In some embodiments, if the information received from merchant 101 is verified, server 161 may send confirmation information to server 111 (S307). In some embodiments, server 111 may also receive at least one question along with a plurality of answer choices (“the question/answer set(s)”) from verification service provider(s) 160 (via its server) (S309). In one aspect, server 111 may display the question/answer set(s) on an interface screen on client 121. Merchant user 101 may choose one answer choice from the plurality of answer choices for each corresponding question. In some embodiments, server 111 may send the answer choice(s) selected by merchant user 101 to server 161 for further validation (S311). If the answer choice(s) selected by merchant user 101 is validated, server 161 may return a response message reporting the status of success (S313). In some embodiments, server 161 may provide an error message if the information provided by merchant user 101 cannot be verified (S315). For instance, server 161 may return a message such as, for example, “Sorry, We Are Unable to Process Your Account at This Time.”

In some embodiments, if the answer choice(s) is validated, server 111 may create a merchant account profile for merchant 120, and store the account information in a database (S317). Server 111 may also be configured to provide a gateway account to merchant 120 (S319). The disclosed embodiments may be configured to store software instructions that are executed by one or more processors to perform one or more of the operations described above in connection with FIG. 3.

FIG. 4 is a flowchart of an exemplary merchant account application process consistent with certain disclosed embodiments. The exemplary merchant account application process may be provided through the real-time API configured in accordance with the disclosed embodiments. As described above, in some embodiments, merchant 120/merchant user 101 may receive an application ID in the enrollment process. Merchant user 101 may use client 121 to apply for a merchant account, and the application ID may be used in the request-response calls between server 111 and client 121. In one aspect, upon receiving the request from client 121, server 111 may return a response message and start collecting information from merchant user 101 via client 121 for processing the application for a merchant account (step 410). In some embodiments, merchant user 101 may send HTTP request to server 111 by entering an URL or clicking a link via a web browser on client 121. Alternatively, client 121 may install an application on client 121, the application may be written against the API that is implemented by server 111. In this case, merchant user 101 may use mechanisms provided by the application stored on client 121 to send the request. Server 111 may generate and provide information for display on a merchant account application web page that may be displayed on client 121. In some embodiments, server 111 may require client 121 send a POST request (via an application or a web browser) to server 111, the POST request enclosing values to be passed to one or more parameters. In one aspect, the values to be passed to one or more parameters enclosed in the POST request message's body may be in JSON format. In some embodiments, exemplary parameters configured in the real-time API consistent with disclosed embodiments may include those shown in FIGS. 5A-C. In one aspect, exemplary parameters, such as those shown in FIGS. 5A-C, may be set as required or optional. In another embodiment, the API may also require the exemplary parameters to conform to certain descriptions, such as, for example, the descriptions illustrated in FIGS. 5A-5C.

As explained, server 111 may require personal information associated with merchant user 101 in the merchant enrollment and underwriting process. In this scenario, the POST request from client 121 may also enclose information relating to merchant user 101. Parameters as shown in FIG. 5B illustrates some examples of information relating to merchant user 101.

Additionally, in some embodiments, merchant user 101 may be a sole proprietor of merchant 120. In this case, merchant user 101 may provide additional information via client 121 in the enrollment process. FIG. 50 illustrates a list of exemplary parameters, the values of which may be contained in the POST request when merchant user 101 is a sole proprietor.

In one aspect, server 111 may verify the information received from merchant user 101 via client 121 (step 420). If the information provided by merchant user 101 via client 121 is correct, server 111 may return a response message containing the success status and an enrollment ID. In another aspect, if the information is incorrect (e.g., the email address format is wrong), server 111 may return a response message containing the failure status and a description of the error that gives rise to the failure. FIG. 16 (discussed in detail later) shows a list of error codes used when errors are encountered. A sample JSON response from server 111 may include, for example, the following:

Sample JSON Response

Return Data
{

″status”: “Success″,
″enrollment_id″: ″0BF148EB-D390-360A-94CE-BF60AB33031D″,

}
-OR-
{

″status″: ″Failure″,
″errors″:
[

{

″reason″: ″Invalid Email Address″,
″code″: ″arg.invalid.email″

},
...

],

}

As explained, the information provided by merchant user 101 may be verified by server 111 in some embodiments. In one aspect, the verification process may be performed by verification service provider 160 via server 161. For example, server 111 may initiate a verification call to server 161 to verify the information provided by merchant user 101 via client 121. Using the information relating to merchant user 101 and/or merchant 120 stored in a database included in verification service provider 160, server 161 may be configured to verify the information provided by merchant user 101 and send the verification results to server 111, via network 140. In some embodiments, the information exchange between server 111 and server 161 may be in the form of server-to-server communication, which may allow the application of merchant accounts to be processed in real-time. In one aspect, server 161 may also be configured to evaluate the risk factors associated with merchant user 101 and/or merchant 120. In one aspect, server 161 may perform the risk factor analysis based on the information provided by merchant user 101, information stored in its database, and/or information stored in one or more databases provided by other institutions. In one aspect, server 161 may send the risk factor analysis to server 111. In some embodiments, based on the risk factor analysis from server 161, server 111 may provide algorithms and matrixes for determining the initial transaction limits that merchant 120 may receive from financial service provider 110 in connection with processing financial card payments.

In some embodiments, server 111 may be configured to further verify the identification of merchant user 101 and/or merchant 120. For example, client 121 may send a Get request for questions, and server 111 may perform operations that generate a display screen on client 121 containing at least one question with a plurality of answer choices to the question (“the question/answer set(s)”) (step 430). In one aspect, merchant user 101 may send a GET request via client 121 (e.g. web browser on client 121 or an application using the API stored on client 121). The GET request may enclose values including, for example, the application ID associated with merchant 120 and the enrollment ID returned by server 111 at step 410. The values enclosed in GET request may be passed to the exemplary parameters as shown in FIG. 6.

In one aspect, financial service provider 110 may include one or more databases for storing the question/answer set(s). Additionally or alternatively, verification service provider 160 may include one or more databases that store the question/answer set(s) and also the correct answer choices to the questions. In the latter case, server 111 may send a request to server 161 to retrieve the correct answer choice(s) to question/answer set(s).

In some embodiments, server 111 may return JSON-format array of hashes containing the question/answer set(s) to be displayed to merchant user 101 on client 121. A sample JSON response containing the question/answer set(s) may include, for example, the following:

Sample JSON Response

Return Data
{

″enrollment_id″ : ″0BF148EB-D390-360A-94CE-
BF60A333031D″, ″status″ : ″Success″,
″activate_questions″ : [

{

″text″ : ″In which of these cities have you
lived?″, ″id″ : ″city.lived.in″,
″choices″ : [

″HEMET″,
″CALIMESA″
, ″SAN
DIEGO″,
″SAN JUAN CAPISTRANO″,
″None of the above″

]

},
{

″text″ : ″With which of these addresses have you been

associated?″,

″id″ :
″address.association″,
″choices″ : [

″866 WINDSOR DR″,
″447 VFW PKWY″,
″1234 RIGHT ST″,
″44 GRANVILLE
RD″,
″None of the above″

]

}

]

}
-OR-
{

″status″:
″Failure″,
“errors”:
[

{

″reason″:″enrollment_id is
invalid″,
″code″:″arg.invalid.enrollment_id
″

}

],

}

In some embodiments, server 111 may be configured to receive and validate answer choice(s) selected by merchant user 101 (step 440). For example, merchant user 101, via web browser on client 121 or an application installed on client 121 that is written against the API, may send a POST request to server 111 enclosing the answer choice(s) selected by merchant user 101. The POST request may also enclose values to be passed into parameters including, for example, the application ID and the enrollment ID. Exemplary parameters as shown in FIG. 7 illustrates some examples of values required for the process of validating answer choice(s).

As explained, server 161 may have one or more databases storing the correct answer choice(s) to the question/answer set(s) displayed to merchant user 101 via client 121. In some embodiments, server 161 may be configured to perform operations for validating the answer choice(s) provided by merchant user 101. In one embodiment, after receiving the answer choice(s) from client 121, server 111 may send the answer choice(s) to server 161. Using the stored correct answer choice(s) in its database, server 161 may verify the selected answer choice(s) provided by merchant user 101, and send the verification results back to server 111.

In some embodiments, server 111 may return a response message containing the status of the POST request received from client 121. Sample JSON response from server 111 may include, for example, the following:

Sample JSON Response

Return Data
{“status”: ”Success”}
-OR-
{

″status″:
″Failure″,
″errors″:
[

{

″reason″: ″Invalid
Response(s)″, ″code″:
″arg.invalid.activation″

}

],

}

In some embodiments, if server 111 validates the answer choice(s) from merchant user 101, server 111 may activate client 121 (step 450). In one aspect, client 121 may send a request to server 111 for activating client 121, the request may include values to be passed to parameters for activating the device. The values may include, for example, the application ID and the enrollment ID associated with merchant 120. The exemplary parameters as shown in FIG. 8 illustrate the values required for activating client 121. Server 111 may return response messages containing the status of the request for activating client 121 (e.g., success or failure). The response from server 111 may also include client ID, username, and password associated with a merchant account to be issued to merchant 120. Sample JSON response from server 111 may include, for example, the following messages:

Sample JSON Response

Return Data
{

“status”: “Success”,
“client_id”:“asdf123”,
“username”:“fsmith3029”,
“password”:“smithpass123”,
“api_token”:“0BF147EB-D390-360A-9eCE-BF60cd33839A”,
“api_secret”:“HL5KrGoro0V67jf4FIKM”

}
-OR-
{

“status”: “Failure”, “errors”:
[

{

“reason”: “enrollment_id is invalid”,
“code”:“arg.invalid.enrollment_id”

},
...

],

}

The disclosed embodiments may also perform processes that include authenticating merchant user 101 and/or client 121 (step 460). As an example, server 111 may be configured to authenticate merchant user 101 by sending a password used for activating the merchant account to a contact method provided by merchant user 101. For example, server 111 may send the password (e.g., the password received at step 450) to an email address provided by merchant user 101. In one aspect, merchant user 101 may use the received password to access server 111 to activate the merchant account on behalf of merchant 120. The exemplary parameters shown in FIG. 9 may illustrate the values required or used for authenticating merchant user 101.

Additionally, authenticating process may be used to grant the application stored on client 121 the ability to access information on server 111 on the behalf of merchant user 101 and/or merchant 120, such as, for example, in configurations where client 121 is a mobile device storing an application that uses the disclosed real-time API for processing merchant enrollment and underwriting process. Client 121 may send server 111 information including, for example, device_id and device_key (must be specified together), or a pin specified by a user of client 121 (e.g., merchant user 101). FIG. 10 shows exemplary input parameters associated with the process of authenticating client 121.

In some embodiments, server 111 may return a response message containing the status of the request for authenticating merchant user 101 and/or client 121. The status message may include, for example, “Success,” or “Not Found,” or “Account Locked”. In one aspect, if the status is “Success,” the response message from server 111 may also contain gateway client ID, gateway username, and gateway password associated with the merchant account. Gateway information may be used for processing financial service transactions such as, for example, processing financial card payments for goods and/or services provided by merchant 120. In another aspect, if the status is “Success,” the response message from server 111 may also contain API token and API secret for requests requiring prior authentication of client 121. Sample JSON response from server 111 may include, for example, the following messages:

Sample JSON Response

Return Data
The pin and device_key elements will only be returned if previously set
via
/set_credentials. Additionally, you must supply a device_id in order to
get back a
device_key.
{

“status”: “Success”,
“client_id”: “asdf123”.
“username”: “fsmith3029”,
“password”:
“smithpass123”,
“api_token”: “0BF147EB-D390-360A-9eCE-
BF60cd33839A”, “api_secret”:
“HL5KrGoro0V67jf4FIKM”,
“pin” : “1234”,
“device_key” : “bed5744f718362aa411c8d1cd2d77993”

}
-OR-
{

“status”: “Enrollment Incomplete”,
“enrollment_id”: “0BF148EB-D390-360A-94CE-BF60AB33031D”

}
-OR-
{

“status”: “Not Found”

}
-OR-
{
“status”: “Account Locked”
}

In some embodiments, server 111 may be configured to check the zip code provided by merchant user 101. For example, client 121 may send server 111 a request including information such as, for example, the application ID associated with merchant user 101, and the zip code provided by merchant user 101. FIG. 11 shows exemplary input parameters associated with zip code checking process. Server 111 may send a response message including the status of the request (e.g., “Success” or “Failure”). Sample JSON response from server 111 may include, for example, the following messages:

Sample JSON Response

Return Data
{

“zip” : “40207”,
“cities” : [

{

“city” : “LOUISVILLE”,
“state” : “KY”

},
{

“city” : “SAINT MATTHEWS”,
“state” : “KY”

},

],
“status” : “Success”

}
-OR-
{

“status”: “Failure”,
“errors”:
[

{

“reason”: “zip_code is invalid”,
“code”: “arg.invalid.zip_code”

}

],

}

In some embodiments, server 111 may also send a list of plans available for merchant enrollment and underwriting to client 121. To retrieve an up-to-date list of plans, client 121 may perform refresh function before sending the request for the list of plans. In some embodiments, server 111 may be configured to provide the list of plans during the process of collecting information associated with merchant user 101 and/or merchant 120 (e.g., at step 410). For example, an application stored on client 121 may call an enrollment method and provide the application ID associated with merchant user 101. FIG. 12 shows exemplary input parameters associated with plan listing process. Server 111 may respond to the enrollment method call and provide the list of plans. Sample JSON response from server 111 may include, for example, the following messages:

Sample JSON Response

Return Data
The “plans” element is an array of hashes, each representing a separate
plan. The keys beginning with “dflt_” are the default rates for the plan.
One or more card types may have a special rate, indicated by a matching
key name prefixed by one of:
mc_ = MasterCard
visa_ = Visa
amex_ = American Express
disc_ = Discover
In the absence of a card-specific value, the dflt_ version applies.
{

“status” : “Success”,
“plans” : [

{
“plan_id” : “5”,
“name” : “Starter”,
“monthly_service_charge” : “0.00”,
“dflt_keyed_rate” : “3.75000”,
“dflt_keyed_tx_fee” : “0.00000”,
“dflt_swipe_rate” : “2.75000”,
“dflt_swipe_tx_fee” : “0.00000”,
“visa_keyed_rate” : “”,
“visa_keyed_tx_fee” : “”,
“visa_swipe_rate” : “”
“visa_swipe_tx_fee” : “”,
“mc_keyed_rate” : “”,
“mc_keyed_tx_fee” : “”,
“mc_swipe_ rate” : “”,
“mc_swipe_tx_fee” : “”,
“amex_keyed_rate” : “3.75000”,
“amex_keyed_tx_fee” : “”,
“amex_swipe_rate” : “2.95000”,
“amex_swipe_tx_fee” : “”,
“disc_keyed_rate” : “”,
“disc_keyed_tx_fee” : “”,
“disc_swipe_rate” : “”,

“disc_swipe_tx_fee” : “”

},

...

]

}

In some embodiments, client 121 may use the API to receive a list of industry types available for merchant enrollment and underwriting from server 111. To retrieve an up-to-date list of industry types, client 121 may perform refresh function before sending the request for the list of industry types. In some embodiments, server 111 may provide the list of industry types during the process of collecting information associated with merchant user 101 and/or merchant 120 (e.g., at step 410). For example, an application stored on client 121 may call an enrollment method and provide the application ID associated with merchant user 101. FIG. 13 shows exemplary input parameters associated with industry type listing process. Server 111 may return a response message containing various industry types. Sample JSON response from server 111 may include, for example, the following messages:

Sample JSON Response

Return Data
{

“status″ : “Success”,
“types” : [

{
“label” : “Apparel & Accessories”,

“id” : “1”

},
{

“label” : “Art Dealers & Galleries”,
“id” : “2”

},

...

]

}

In some embodiments, to test the reachability of server 111 and to measure the round-trip time for messages sent from server 111 to client 121, client 121 may perform Ping operations. FIG. 14 shows exemplary parameters for performing Ping operation. Server 111 may respond to the Ping command with messages containing, for example, the following:

Return Data
{

“pong” : 1,
“status” : “Success”

}

Additionally, the disclosed embodiments may perform warning operation during the process of merchant enrollment and underwriting. In some embodiments, a warning message may be triggered when a non-final condition occurs. For example, a warning message may be triggered when a financial payment transaction has been processed but a receipt may not be provided. FIG. 15 shows an exemplary table of warning code. In some aspect, a successful response may include a warning section. Server 111 may send warning messages containing, for example, the following:

{

“status”: “Success”,
“warnings”:
[

{

“code”:“Iam.warning.you”,
“reason” : “This is your final warning.”

}

],

}

As explained, the API utilizes a series of request-response calls between server 111 and client 121. In some embodiments, the request-response calls may return an error response when an error is encountered (e.g., email format is wrong, SSN number cannot be verified, and etc.). FIG. 16 illustrates exemplary error codes and their descriptions. In one aspect, server 111 may be configured to use standard HTTP error code syntax. Additional information included in the body of the error response and may be JSON-formatted. For example, a sample JSON-formatted response may include the following information:

Sample JSON-formatted Response

{

“status”: “Failure”,
“error”:
[

{

“code”: “arg.invalid.something”,
“reason”: “something failed”

}

],

}

Additionally or alternatively, disclosed embodiments may be configured to use industry standard models. In one aspect, situations may arise where personal information associated with merchant enrollment and underwriting (e.g., name, address, SSN, and etc.) may be stored across multiple identity management systems. In these situations, API may be configured to facilitate the universal access and distribution of information across the multiple identity management systems. In some embodiments, server 111/211 may be configured to provide an OAuth interface that allows a third party client (not shown) to access server 111/211 on behalf of client 121/221 and/or merchant user 101/201. For example, merchant user 101 may authorize a third party application installed on a third party client to interact with the API on its behalf in performing processes associated with merchant enrolling and underwriting consistent with the disclosed embodiments.

The disclosed embodiments may be associated to different types of financial services. Any financial institution that provides merchant service systems to merchant may employ systems, methods, and articles of manufacture consistent with certain principles related to the disclosed embodiments. In addition, other types of entities, such as a merchant, retailer, or other type corporate entity that may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples, but instead are defined by the appended claims in light of their full scope of equivalents.

1. A system providing a merchant financial account, comprising:
one or more memory devices storing software instructions; and
one or more processors configured to execute the software instructions to:
receive, from a first computing device, a request for applying for the merchant financial account for a merchant applicant, the request including merchant applicant information,
verify the information associated with the merchant applicant,
provide, via the first computing device, at least one question with a plurality of answer choices to the merchant applicant when the merchant applicant information associated with the applicant is verified,
receive an answer choice to the at least one question from the merchant applicant via the first computing device,
validate the received answer choice,
activate the first computing device when the answer choice is validated, and
authenticate the merchant applicant for the merchant financial account.

2. The system of claim 1, further comprising a second computing device, wherein the one or more processors are configured to receive the at least one question with the plurality of answer choices from the second computing device.

3. The system of claim 1, wherein the merchant financial account is a merchant account for processing financial card payments.

4. The system of claim 1, wherein the one or ore processors are configured to execute the software instructions through a real-time API, the real-time API being configured to provide real-time merchant financial account configuration processes with a financial service provider.

5. The system of claim 4, wherein the real-time API is configured to provide real-time merchant financial account configuration processes by utilizing a plurality of request and response calls.

6. The system of claim 1, wherein the one or more processors are configured to provide a list of industry types or plans available to the merchant applicant.

7. The system of claim 1, wherein the one or more processors are configured to determine one or more financial restrictions of merchant services associated with the merchant financial account based on a risk evaluation result.

8. A computer-implemented method for providing a merchant service account application, comprising:
receiving, from a first computing device and through a real-time API configured to provide real-time merchant financial account configuration processes with a financial service provider, a request for applying for the merchant financial account for a merchant applicant, the request including merchant applicant information;
verifying the information associated with the merchant applicant;
providing, via the first computing device, at least one question with a plurality of answer choices to the merchant applicant when the merchant applicant information associated with the applicant is verified;
receiving an answer choice to the at least one question from the merchant applicant via the first computing device;
validating the received answer choice;
activating the first computing device when the answer choice is validated; and
authenticating the merchant applicant for the merchant financial account.

9. The method of claim 8, wherein the real-time API is configured to provide real-time merchant financial account configuration processes by utilizing a plurality of request and response calls.

10. The method of claim 8, further comprising providing a list of industry types or plans available to the merchant applicant.

11. The method of claim 8, further comprising determining one or more financial restrictions of merchant services associated with the merchant financial account based on a risk evaluation result.

12. The method of claim 8, further comprising providing a status of the merchant applicant authentication.

13. The method of claim 8, further comprising providing a warning message associated with the merchant service account application indicating an occurrence of a non-final condition.

14. The method of claim 8, wherein the merchant financial account is a merchant account for processing financial card payments.

15. A non-transitory computer readable medium storing instructions that, when executed by a processor, cause the processor to:
receive, from a first computing device, a request for applying for a merchant financial account for a merchant applicant, the request including merchant applicant information;
verify the information associated with the merchant applicant;
provide, via the first computing device, at least one question with a plurality of answer choices to the merchant applicant when the merchant applicant information associated with the applicant is verified;
receive an answer choice to the at least one question from the merchant applicant via the first computing device;
validate the received answer choice;
activate the first computing device when the answer choice is validated; and
authenticate the merchant applicant for the merchant financial account.

16. The medium of claim 15, wherein the instructions further cause the processor to determine one or more financial restrictions of merchant services associated with the merchant financial account based on a risk evaluation result.

17. The medium of claim 15, wherein the instructions further cause the processor to provide a list of industry types or plans available to the merchant applicant.

18. The medium of claim 15, wherein the instructions further cause the processor to:
provide a status of the merchant applicant authentication; and
provide a warning message associated with the merchant service account application indicating an occurrence of a non-final condition.

19. A system for providing merchant accounts for transacting financial card transactions with customers, comprising:
a memory storing a real-time API that is configured according to parameters to enable communications with a financial service provider for configuring a merchant account for a merchant; and
one or more processors configured to execute software instructions to use the real-time API to perform one or more operations, including:
collecting individual information, including a name of an individual representing a merchant and merchant information associated with the merchant,
automatically providing the individual information and merchant information to a verification service provider for verifying the identity of the individual to act on behalf of the merchant and for analyzing risk-mitigating factors associated with the individual and merchant information,
automatically presenting information relating to a gateway account in response to a verification result received from the verification service provider, the gateway account being associated with a processing gateway, and
receiving notification of a pre-built customer account record on an acquiring system that is associated with the gateway account, and of functioning credentials for transacting financial card payments from customers of the merchant using the merchant account.

20. The system of claim 19, wherein the merchant information includes a merchant name, a merchant business address, tax information associated with the merchant, a merchant telephone number, or merchant website identification information.
